(19) United States
(12) Patent Application Publication
(10) Pub. No.: US 2004/0062614 A1
(43) Pub. Date: Apr. 1, 2004

(54) Reinforcement connection for pre-cast wall panel

(76) Inventor: Robert B. Anderson, Alpharetta, GA (US)

Correspondence Address: JACOBSON HOLMAN PLLC, 400 SEVENTH STREET N.W., SUITE 600, WASHINGTON, DC, 20004, US

(21) Appl. No.: 10/656,150

(22) Filed: Sep. 8, 2003

Related U.S. Application Data
(60) Provisional application No. 60/414,340, filed on Sep. 30, 2002.

(51) Int. Cl. E21D 20/00; E02D 3/02; F16B 7/00

(52) U.S. Cl. 405/262; 405/284; 403/292

(57) ABSTRACT

A method of constructing a retaining wall by connecting one or more layers of reinforcing sheet material, such as a polymeric geogrid, to the rear of one or more wall panels via slots defined in the rear walls of the panels having an angular locking section inside the panels adapted to retain U-shaped end sections of the reinforcing material carrying a connection bar that is cammed into the locking sections of the slots by a wedge.

This is a complete application claiming benefit of provisional application Serial No. 60/414,340 filed Sep. 30, 2002.

### BACKGROUND OF THE INVENTION

1. Technical Field

This invention relates to a mechanical connection for one or more tie-back sheets of reinforcement material with the rear face of a pre-cast wall panel, a method of forming a reinforced retaining wall therefrom, and the resultant retaining wall itself.

2. Description of the Prior Art

Retaining walls are commonly used for architectural and site development applications. The wall facing must withstand very high pressures exerted by backfill soils. Reinforcement and stabilization of the soil backfill is commonly provided by sheet-like reinforcing materials that are placed in layers in the soil fill behind the wall face to interact with the wall fill soil and create a stable, reinforced soil mass. Connection of the reinforcing material to the elements forming the wall secures the wall facing and minimizes soil backfill pressures.

One form of reinforcing sheet material connection device is seen in U.S. Pat. No. 5,568,998 (the '998 patent), the subject matter of which is incorporated herein in its entirety by reference. The '998 patent also makes reference to a brochure entitled “Concrete Geowall Package” published by The Tensar Corporation in 1986 showing various retaining wall structures comprising cast concrete panels, the subject matter of which is also incorporated herein in its entirety by reference. In the Concrete Geowall Package brochure, one such retaining wall structure comprises the incorporation of short strips or tabs in the nature of a grid-like sheet such as seen in U.S. Pat. No. 4,374,798 (the '798 patent), the subject matter of which is also incorporated herein in its entirety by reference. Grid-like tieback sheets, also known as “geogrids”, can be integrally formed as in the '798 patent or knitted, woven or formed of strips of material glued to each other at their crossing points. All of these forms of geogrid material are well known for use as reinforcing means in the construction of retaining walls. The tabs of geogrid embedded in the cast wall panel of the Concrete Geowall Package brochure are connected on site to extended strips of geogrid used to reinforce the wall fill by what has come to be known as a “Bodkin” joint. In the '998 patent, a pair of short strips or tabs of geogrid are embedded in the cast wall panel and an extended sheet of the geogrid connected to the tabs by a connector comb and locking clip arrangement.

Both the connector comb connection of the '998 patent and the Bodkin connection of the Concrete Geowall Package brochure require embedding short strips or tabs of a geogrid material in the concrete wall panel as it is cast for attachment to the extended sheets of geogrid as a wall is built. While these types of connections are effective, the precasting of the geogrid tabs into the wall causes some complications in the manufacture of the panels. Further, the short strips of geogrid extending from the panel can be damaged during handling, particularly if the concrete wall panels are stacked for transportation to a work site. Finally, both the connection of the '998 patent and the Concrete Geowall Package brochure require the use of a grid-like sheet reinforcement since they each rely on the openings in the sheet to complete the connection between the tabs and the extended sheets of geogrid. For many applications, the use of other than a grid-like sheet of reinforcing material is preferred, either because of the particular nature of the wall being built or to reduce the cost of the reinforcement.

While integral geogrids of the type produced by the process of the '798 patent have significant advantages over other reinforcing materials due to the high strength of such materials under stress and the ability of the backfill soil to “strike through” the grid apertures, other grid-like sheet reinforcing materials, as well as other continuous sheet reinforcing materials, are commonly used in the production of reinforced retaining walls and the like. For example, reference is made to the bonded composite open mesh structural textiles of U.S. Pat. No. 5,965,467 (the '467 patent) and the bonded composite knitted structural textiles of U.S. Pat. No. 5,795,835 (the '835 patent), the subject matter of each of which is also incorporated herein in its entirety by reference. Other woven, knitted or even extruded forms of grid-like material or woven, knitted, non-woven or extruded continuous sheet material are well-known to those with ordinary skill in the art for use as reinforcement in the production of retaining walls and the like. The ability to provide a connection for substantially any kind of sheet-like reinforcement material to a precast wall panel would obviously be desirable.

### SUMMARY OF THE INVENTION

It is a primary object of this invention to provide a simple and inexpensive precast wall panel and a system formed of a plurality of precast wall panels incorporating a highly effective connection device for securing extended lengths of sheet-like reinforcing material to the wall panels.

It is a further object of this invention to provide a precast wall panel system and a method for forming a retaining wall incorporating a connection device which provides a secure interconnection between reinforcing sheet material and selected wall panels without the need for incorporating projecting tabs or other forms of attachment strips to the wall panel during the casting thereof.

Yet another object of this invention is to provide a connection system for use with a precast wall panel which enables the interconnection of sheet-like material of substantially any form to the wall panel, whether the sheet-like material be grid-like, continuous, extruded, bonded strip or element, woven or knitted, or even solid.

A still further object of this invention is to provide a concrete or the like wall panel having one or more unique connection slots defined therein during casting for subsequent insertion of a sheet-like reinforcing material and a locking bar adapted to secure the same in the connection slot.

Still another object of this invention is the provision of a method of interconnecting a sheet-like reinforcing material to a precast concrete or the like wall panel which is simple and effective, providing a secure interlock between the reinforcing material and the wall panel, while enabling the connection to be easily disengaged, if necessary.

These and other objects of this invention, as well as many of the attendant advantages thereof, will become more readily apparent when reference is made to the following description taking in conjunction with the accompany drawings.

### BRIEF DESCRIPTION OF THE DRAWINGS

FIG. 1 is a rear elevational view of one form of precast, concrete panel according to the instant inventive concepts;

FIG. 2 is a transverse, cross-sectional view taken along lines A-A of FIG. 1;

FIG. 3 is a schematic view showing the portion of a precast concrete panel of FIG. 1 enlarged to illustrate the shape of the connection slot, with portions of a sheet-like reinforcement material wrapped around a connection bar prior to engagement with the panel member;

FIG. 4 illustrates the manner in which the connection bar/reinforcing material is initially engaged with the connection slot;

FIG. 5 is a similar view schematically illustrating the manner in which the connection bar is rotated by a wedge element to angle the trailing edge of the bar upwardly;

FIG. 6 is a similar view showing the connection bar fully angled and pulled into locking engagement in the connection slot; and

FIG. 7 is a schematic side elevational view of portions of a precast concrete wall panel with a pair of vertically spaced sheets of reinforcing material engaged therewith according to this invention, and tensioned by backfilled aggregate such as soil or the like.

Like reference characters refer to like parts throughout the several views of the drawings.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

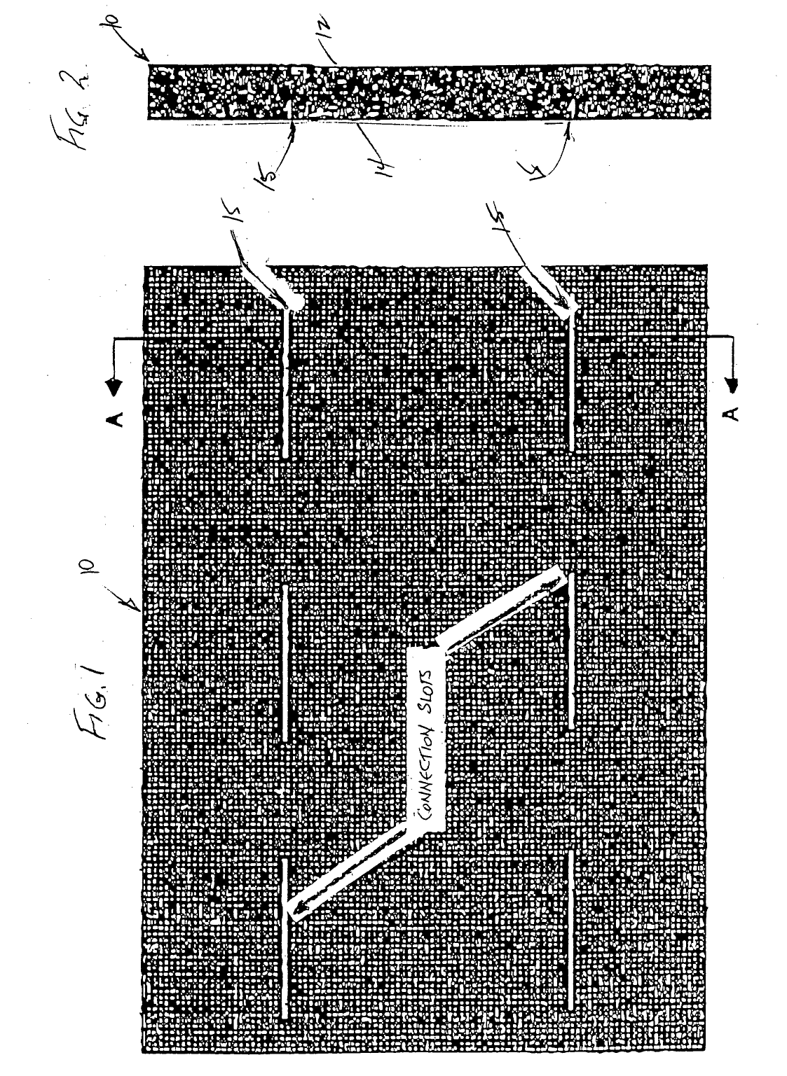

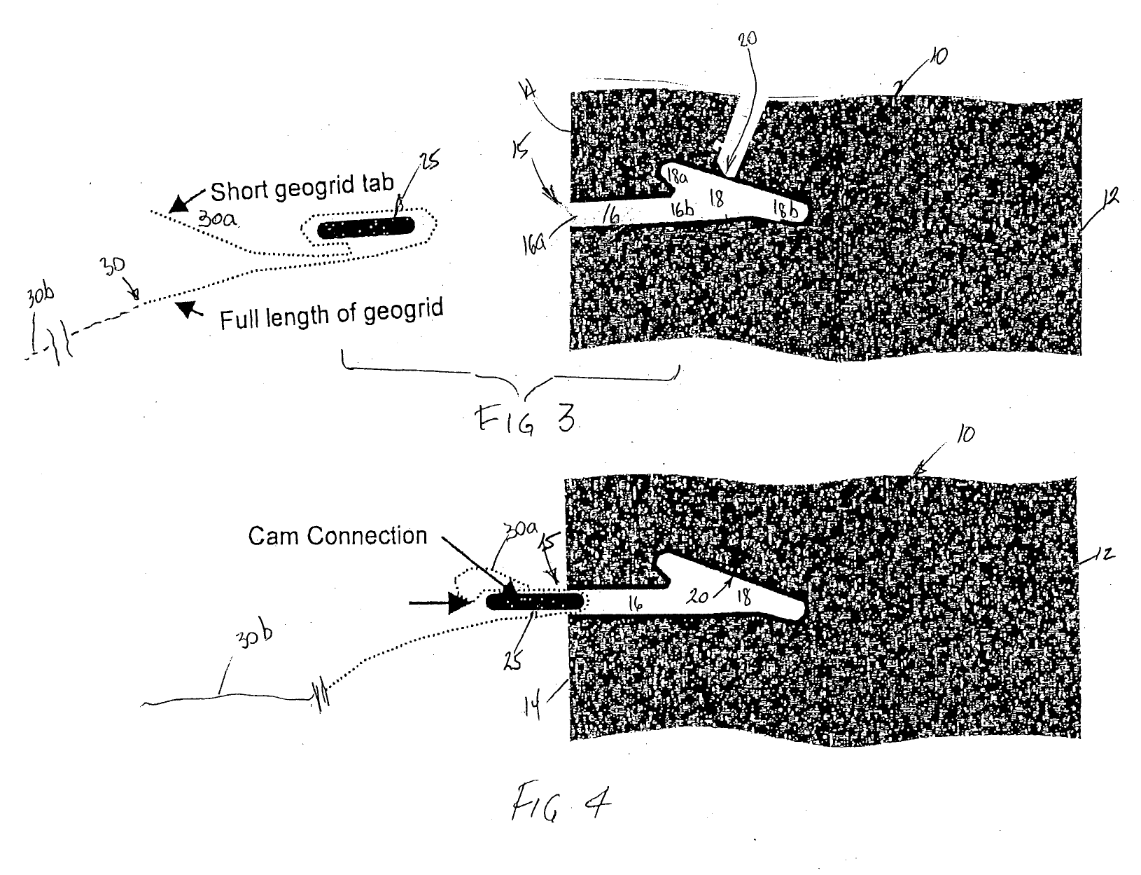

Referring now to the drawings in general, and more particularly to FIGS. 1 and 2, a precast concrete panel member or the like according to this invention is designated generally by the reference numeral 10. The size of the panel 10, as well as the material of construction and the way in which adjacent panels are interconnected, laterally and/or vertically, to each other, if at all, are not relevant to the instant inventive concepts. Ordinarily, such panels are cast from a cementitious material such as concrete and are relatively large in width and height, compared to their thickness as seen in FIGS. 1 and 2.

A plurality of connection slots 15 are formed in the panel, the number and position of which also not being critical to the instant inventive concepts. As shown in FIGS. 1 and 2, six such connection slots 15 of limited width and in groups of three in two vertically-spaced rows are illustrated as exemplary. If desired, elongated connection slots may be provided, even extending from side to side of the panel member 10, although a more secure connection according to this invention is enabled by the use of connection slots corresponding in width to the width of an individual sheet of reinforcing material. This minimizes the quantity of concrete removed from the panel member, thereby limiting any reduction in strength resulting therefrom, and defines the position and spacing of the reinforcing sheets in the ultimate retaining wall. Further, by not extending the slots to the sides of the panel, the possibility that a connected reinforcing sheet can slide laterally free of the panel is obviated.

With reference to FIGS. 3-6 further details of the connection system according to this invention will be seen. In FIG. 3, a small section of the panel member 10 is greatly enlarged to show the details of a connection slot 15. The panel member 10 includes a front surface 12 which will form part of the retaining wall outer surface, and a rear wall 14 which will be backfilled as explained in further detail hereinafter.

When casting the panel member 10, an extruded plastic or the like slot-forming element 20 is fixed in the mold in a well-known manner to produce a void which forms the connection slot 15. Generally, the element 20 is secured in the concrete panel 10 during the casting operation and retained therein thereafter. The manner of forming the slot or making the slot-forming element 20 is known to those with ordinary skill in the art and not part of the instant inventive concepts. Preferably, however, slot-forming element 20 is formed of polyvinyl chloride or the like and will have water blocks as is well known (not shown) to prevent moisture from passing between the element 20 and the concrete from which the panel member 10 is formed which might otherwise deteriorate elements forming part of the reinforcing sheet connection.

The slot 15 includes an elongated entry portion or tunnel 16 which terminates at one end 16a in the rear wall 14 of the panel member 10 to define the entrance openings seen in FIG. 1. Preferably, the entry portion 16 of the connection slot 15 is angled slightly downwardly toward the rear 14 of the panel member 10 to permit any water that enters the connection slot 15 to drain through the opening at 16a. The other end 16b of the entry portion 16 of the connection slot 15 intersects with an angled portion or locking section 18 of the connection slot 15 having an upward and rearwardly extending portion 18a and, preferably, a downwardly and forwardly extending portion 18b.

A connection bar 25 is provided to lock the proximal or trailing end portions 30a of a sheet of reinforcing material 30 to the panel member 10. The connection bar 25 is preferably formed of aluminum, but can be formed of any other relatively rigid material such as steel or even a polymer such as polyvinyl chloride. The thickness of the connection bar 25 from top surface to bottom surface is such as to permit the same to slide through the entry portion 16 of the connection slot 15 even when wrapped by the trailing end portions 30a of reinforcing sheet material 30 as illustratively shown at 30. The width of the connection bar 25 from end to end can correspond to, or be shorter than, the width of its respective connection slot 15 from side to side of the panel member 10. The depth from the leading to the trailing edge of the connection bar 25 must be such as to be capable of being cammed into the angled portion 18 of the connection slot 15 as described below.

For illustrative purposes, the reinforcing sheet material 30 is shown as a geogrid, although, as explained above, it can take any desired sheet form, whether it be an integral geogrid, extruded grid, a woven or knitted grid, or a sheet material without openings formed in any manner. As shown in FIG. 3, the trailing end portions 30a of the sheet material 30 are initially wrapped around the connection bar 25 to flex the same if the sheet material 30 is relatively inflexible. This expedient may not be necessary if the sheet material 30 is sufficiently flexible as formed.

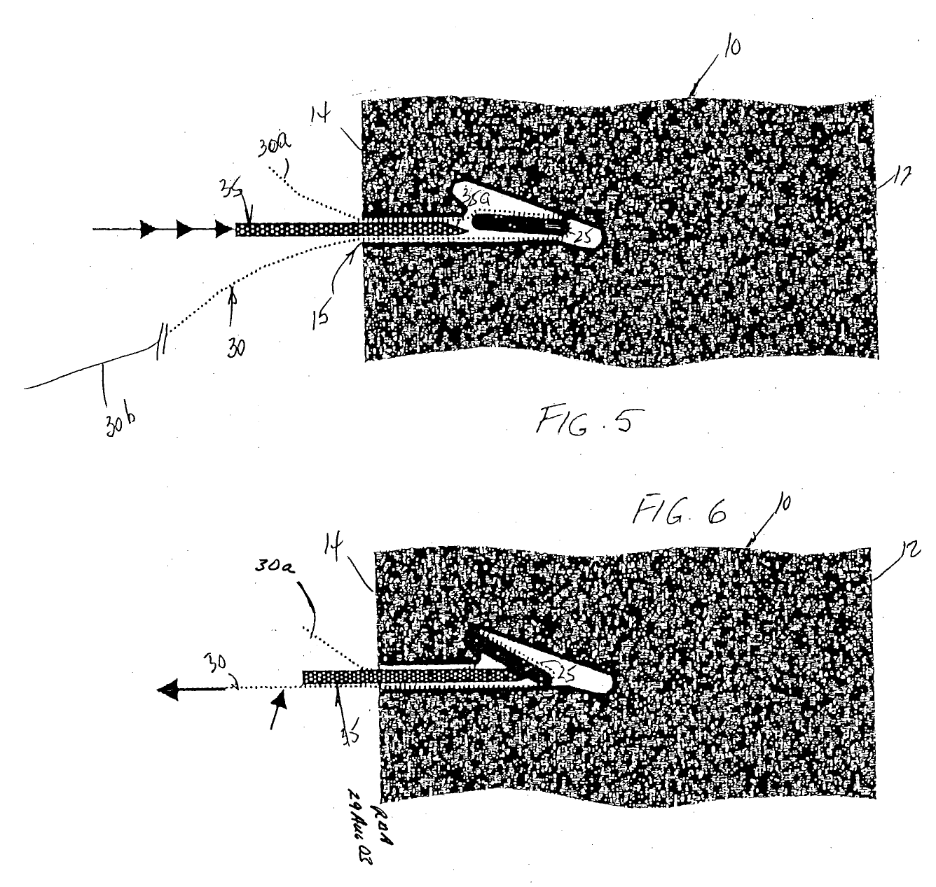

In any event, before inserting a connection bar 25 into the entry portions 16 of the connection slot 15, the trailing end portions 30a of the reinforcing sheet 30 are unwrapped from the trailing edge of the connection bar 25 as seen in FIG. 4 and the bar 25 and reinforcing sheet material 30a are pushed into the connection slot 15 with a short free tab portion 30b extending from the top of the connection bar 25 and the remainder of the elongated sheet material 30c extending below the connection bar 25 to the rear of the panel 10.

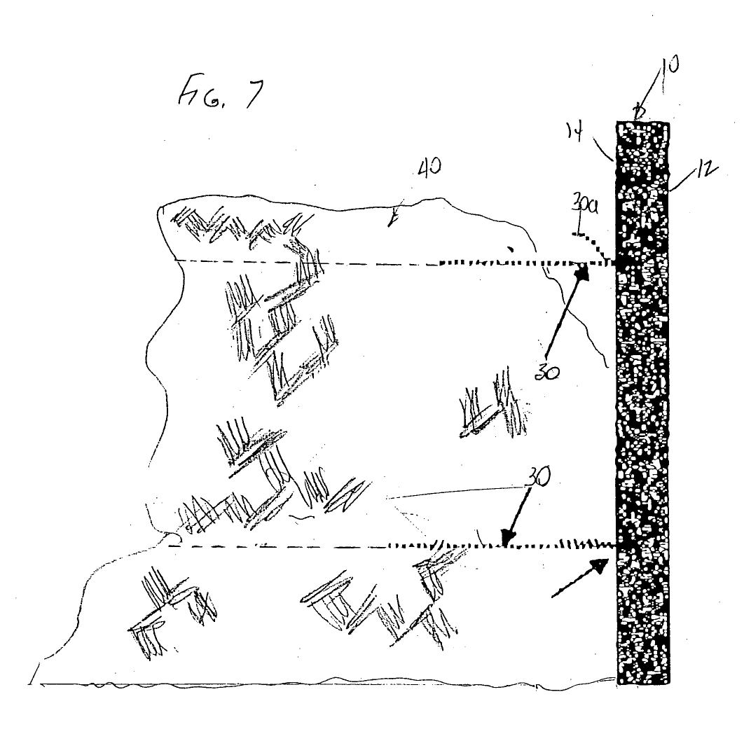

Referring now to FIGS. 5 and 6, in order to complete the connection, one or more cam rotation wedges 35 are hammered into the connection slot 15 to force the connection bar 25 into the angled portion 18 of the connection slot 15 and to rotate the same so that the trailing end of the connection bar 25 is angled upwardly into the upwardly and rearwardly extending portion 18a of the connection slot 15. For this purpose, the forward end of the rotation wedges 35 are preferably angled as seen at 35a. The angled forward end portion of the wedges 35 and the downwardly extending forward end portion 18b of the connection slot 15 are helpful in angling the connection bar 25, but one or both of these expedients may be eliminated in some circumstances.

Once the connection bar 25 has been rotated by the wedges 35, the free end 30b of the sheet material 30 is pulled rearwardly to force the connection bar 25 fully into the upwardly and rearwardly portion 18a of the connection slot 15 as seen in FIG. 6. This action tends to force the wedge 35 rearwardly providing an indication that the connection bar 25 has, in fact, been totally engaged.

As seen in the upper portion of FIG. 7, once the connection has been made, a quantity of a fill material 40, which can be an aggregate such as stone or soil, is placed on the rearwardly extending portion 30c of the reinforcing sheet 30 to place tension on the same and, thereby, lock the connection bar 25 and the reinforcing sheet 30 into engagement with the panel member 10.

The wedges 35 can be removed after the reinforcing sheet material 30 is permanently tensioned and the fill material 40 is in place or the wedges can be left in place as the remainder of the backfill is added during construction of the retaining wall. If, for whatever reason, the sheet material 30 must be disconnected from the panel member 10, it is only necessary to remove the wedges 35 if they were left in position and pull on the untensioned trailing end portions 30b of the sheet material 30 which will withdraw the connection bar 25 through the connection slot 15 and separate the reinforcing sheet material 30 from the panel member 10.

It is believed from the foregoing that the use and operation of the connection system of this invention can now be readily understood by those with ordinary skill in the art. One or multiple sheets of reinforcing material can be connected to selected pre-formed connection slots in the rear face of a precast panel member with fill material tensioning the reinforcing sheet material and, thereby, locking the same to the panel. The reinforcing sheet material stabilizes the fill and protects the concrete panels from forward rotation about their base.

The foregoing descriptions and drawings should be considered as illustrative only of the principles of the invention. As noted, the invention may be configured in a variety of shapes and sizes and is not limited by the dimensions of the preferred embodiment. Numerous applications of the present invention will readily occur to those skilled in the art. Therefore, it is not desired to limit the invention to the preferred embodiments or the exact construction and operation shown and described. Rather, all suitable modifications and equivalents may be resorted to, falling within the scope of the invention.

What is claimed is:

1. In a wall panel for use in the construction of a retaining wall, the wall panel comprising a front face which extends generally vertically in use to define at least a portion of the face of the retaining wall, a rear face behind which, in use, a mass of a fill material is to be provided and wherein the wall panel is to be reinforced by one or more layers of a reinforcing material connected to the wall panel and embedded in the fill material, said panel further including an upper edge, a lower edge, a height extending vertically between said upper and lower edges, a pair of opposed side edges, and a width extending laterally between said side edges, the improvement which comprises:
at least one connection slot defined in said panel for attachment of a sheet of the reinforcing material, said slot having an elongated width extending generally in the same direction as the width of the panel and a height extending generally in the same direction as the height of the panel, said slot including:
a first portion defining an entrance opening communicating with said rear face,
a second portion defining an elongated tunnel extending from said entrance opening into the panel toward said front face and having an inner end spaced from said front face, and
a third portion including a locking section extending toward said rear face of the panel at an angle to said tunnel and communicating with said inner end of said tunnel.

2. The improvement of claim 1 wherein said panel is made of concrete.

3. The improvement of claim 1 wherein said panel includes a multiplicity of spaced connection slots.

4. The improvement of claim 3 wherein certain of said slots are spaced laterally from each other.

5. The improvement of claim 3 wherein certain of said slots are spaced vertically from each other.

6. The improvement of claim 3 wherein certain of said slots are spaced laterally from each other and others of said slots are spaced vertically from each other.

7. The improvement of claim 1 wherein said locking section of said slot extends upwardly toward said rear face of the panel at an angle to said tunnel.

8. The improvement of claim 7 wherein said third portion of said slot includes a continuation of said locking section extending downwardly toward said front face of the panel at an angle to said tunnel.

9. A retaining wall comprising at least one wall panel having a front face which extends generally vertically in use to define at least a portion of the face of the retaining wall, and a rear face, a mass of a fill material behind said rear face of said wall panel, and at least one layer of a reinforcing material connected to said wall panel and embedded in said fill material,
said panel further including an upper edge, a lower edge, a height extending vertically between said upper and lower edges, a pair of opposed side edges, a width extending laterally between said side edges, and at least one connection slot defined in said panel,
said slot having an elongated width extending generally in the same direction as the width of said panel and a height extending generally in the same direction as the height of said panel, said slot including:
a first portion defining an entrance opening communicating with said rear face,
a second portion defining an elongated tunnel extending from said entrance opening into said panel toward said front face and having an inner end spaced from said front face, and
a third portion including a locking section extending toward said rear face of the panel at an angle to said tunnel and communicating with said inner end of said tunnel,
said reinforcing material being sheet-like and including a proximal end section connected to said panel and an extended reinforcing section extending from said rear face of said panel and embedded in said fill material,
said proximal end section being folded back on itself to define a generally U-shaped portion, one end of which is integral with, and a continuation of, said reinforcing section, and the other end of which extends freely, a generally flat connection bar seated in said U-shaped portion and engaged in said locking section of said slot with both ends of said proximal end section of said reinforcing material extending through said tunnel beyond said rear face of said panel.

10. A retaining wall according to claim 9 wherein said panel is made of concrete.

11. A retaining wall according to claim 9 wherein said reinforcing material comprises a continuous sheet of polymeric material.

12. A retaining wall according to claim 9 wherein said reinforcing material is a geogrid.

13. A retaining wall according to claim 9 comprising a plurality of sheets of reinforcing material connected to said panel in vertically spaced relationship.

14. A retaining wall according to claim 9 comprising a plurality of panels in side-by-side abutting relationship, at least some of said panels being connected to sheets of reinforcing material.

15. A retaining wall according to claim 14 wherein a plurality of vertically spaced sheets of reinforcing material are connected to at least some of said panels.

16. A method of constructing a retaining wall comprising
providing at least one wall panel having a front face and a rear face,
said panel further including an upper edge, a lower edge, a height extending vertically between said upper and lower edges, a pair of opposed side edges, a width extending laterally between said side edges, and at least one connection slot defined in said panel,
said slot having an elongated width extending generally in the same direction as the width of said panel and a height extending generally in the same direction as the height of said panel, said slot including:
a first portion defining an entrance opening communicating with said rear face,
a second portion defining an elongated tunnel extending from said entrance opening into said panel toward said front face and having an inner end spaced from said front face, and
a third portion including a locking section extending toward said rear face of the panel at an angle to said tunnel and communicating with said inner end of said tunnel,
temporarily positioning said panel in a generally vertically extending relationship such that said front face defines at least a portion of the face of the retaining wall being constructed,
providing at least one sheet of reinforcing material including a proximal end section and an extended reinforcing section,
folding said proximal end section of said sheet of reinforcing material back on itself to define a generally U-shaped portion, one end of which is integral with, and a continuation of, said elongated reinforcing section, and the other end of which extends freely,
seating a generally flat connection bar within said U-shaped portion of said reinforcing material,
pushing said U-shaped portion of said reinforcing material and said connection bar through said first and second portions of said slot in said panel until said connection bar reaches said third portion of said slot,
providing an elongated wedge with an angular surface on its distal end,
pushing said wedge into said U-shaped portion of said reinforcing material until its distal end engages said connection bar,
angularly camming said connection bar with said wedge until said U-shaped portion of said reinforcing material and said connection bar enter said locking section of said slot with both ends of said proximal end section of said reinforcing material extending through said tunnel beyond said rear face of said panel,
pulling said free end of said reinforcing material to lockingly engage said U-shaped portion of said reinforcing material in said locking section of said slot,
extending said elongated reinforcing section of said reinforcing material rearwardly of said rear face of said panel,
placing a quantity of fill material on said reinforcing section of said reinforcing material, and
repeating the foregoing steps as necessary until said panel is retained in its vertical relationship by the reinforced fill material.

17. A method according to claim 16 wherein said panel is made of concrete.

18. A method according to claim 16 wherein said reinforcing material comprises a continuous sheet of polymeric material.

19. A method according to claim 16 wherein said reinforcing material is a polymeric geogrid.

20. A method according to claim 16 comprising connecting a plurality of sheets of reinforcing material to at least some of said panels in vertically spaced relationship.

21. A method according to claim 16 comprising supporting a plurality of panels in side-by-side abutting relationship to form said retaining wall.

22. A method according to claim 21 comprising connecting a plurality of vertically spaced sheets of reinforcing material to at least some of said panels.
